(19) United States
(12) Patent Application Publication
(10) Pub. No.: US 2026/0318129 A1
(43) Pub. Date: Oct. 15, 2026

(54) LOCKING MECHANISM PART FOR A MOTOR VEHICLE LOCK

(71) Applicant: Kiekert Aktiengesellschaft, Heiligenhaus (DE)

(72) Inventors: Stefan PREUSS, Heiligenhaus (DE); Cyrille ROUSSEL, Mettmann (DE); Philipp MÜLLER, Essen (DE); Ömer INAN, Dorsten (DE); Michael SCHOLZ, Essen (DE)

(73) Assignee: Kiekert Aktiengesellschaft, Heiligenhaus (DE)

(21) Appl. No.: 19/484,046

(22) PCT Filed: Apr. 26, 2024
(86) PCT No.: PCT/DE2024/100378

§ 371 Date: Nov. 13, 2025

(30) Foreign Application Priority Data
May 17, 2023 (DE) 10 2023 113 011.0

(51) Int. Cl. E05B 85/24; E05B 77/36

(52) U.S. Cl. CPC E05B 85/24; E05B 77/36

(57) ABSTRACT

A locking mechanism part, in particular a rotary latch or a pawl, for a motor vehicle lock, the locking mechanism part comprising at least one locking face, a first metallic main body, a second metallic main body and a plastics layer, wherein the plastics layer partially surrounds the main bodies and is arranged at least partially between the main bodies, and wherein the plastics layer at least partially forms a part of the locking face.

The invention relates to a locking mechanism part, in particular a rotary latch or a pawl, for a motor vehicle lock, the locking mechanism part comprising at least one locking face, a first metallic main body, a second metallic main body and a plastics layer, wherein the plastics layer at least partially surrounds the main bodies and is arranged at least partially between the main bodies.

The locking mechanism parts claimed in the present patent application are used in motor vehicle locks, which are also called locking systems or locks in general. The locking mechanism parts form part of a locking mechanism, wherein the locking mechanism interacts with a latch holder that is usually located on the motor vehicle. Through the interaction of the locking mechanism and the latch holder, the locking mechanism can be moved into a ratchet position. Motor vehicle locks differ in that they have a single-latching or double-latching mechanism, i.e., locks with a main ratchet position or locks with a pre-ratchet and a main ratchet position. The locking mechanism consists of a rotary latch and at least one pawl. Locking mechanisms are further differentiated according to whether an opening or closing moment exists in the locking mechanism depending on the ratchet position, so that in the case of an opening moment the pawl must be secured in the ratchet position with another pawl or a blocking lever or ratchet lever. The primary function of the locking mechanism in a motor vehicle lock is to hold the part attached movably to the motor vehicle, held by the motor vehicle lock, in the correct position. Examples of parts attached movably to the motor vehicle include side doors, sliding doors, tailgates, bonnets, hoods, covers or flaps. The aforementioned locking mechanism parts are preferably designed for side doors or tailgates on motor vehicles. The latch holder, which interacts with the locking mechanism, can be attached to a B or C pillar of the motor vehicle, for example, although a reverse arrangement is also frequently used, for example in the case of tailgates.

The locking mechanism parts are usually mounted pivotably on a metallic axle in a metallic lock case of the motor vehicle lock. To increase the stability of the lock, so-called reinforcement plates can also be arranged between the axles of the locking mechanism parts, so that high or very high loads, such as those that occur in extreme situations, can be absorbed. On the one hand, the stability of the locking mechanism in the motor vehicle plays a crucial role, so that the locking mechanism parts are made of steel materials, at least to a large extent and in the load-bearing areas, but on the other hand, the noise behavior of the motor vehicle lock is always taken into account when assessing the quality of the lock.

From DE 10 2008 034 638 A1, a lock unit comprising at least one rotary latch, a first pawl with a pawl rotation axis and a blocking lever, in which the rotary latch, in a locked state of the lock unit, bears against the first pawl with a main ratchet and introduces a pivoting moment into the first pawl, wherein the first pawl is fixed by means of the blocking lever, has become known. The lock unit described above has a plastics layer, at least partially in the area of the main ratchet, to reduce noise generation when the locking mechanism is actuated. The locking mechanism parts are provided with a plastics coating that minimizes noise and is specifically positioned in the area of a locking face between the rotary latch and the pawl. The noise behavior of the vehicle lock can be significantly influenced by the interaction between the locking mechanism parts, rotary latch and pawl, and the arrangement of a plastics layer in the area of the locking face. In particular, high stresses or moments exist between the locking parts in the main detent position. If the locking mechanism parts are separated from each other, a separation bang may occur. To reduce this separation bang and to influence the noise behavior during a relative movement between rotary latch and pawl, the aforementioned plastics layer is used in the area of the locking face.

Besides noise generation, the secure holding of the latch holder, even under extreme conditions, is a key function of the locking mechanism. In order to ensure sufficient stability in the locking mechanism parts on the one hand and to influence the noise behavior on the other, a locking mechanism part which is assembled from several metallic parts has become known from DE 10 2007 041 477 A1. In addition to two main bodies, an insert part is used as a further metallic part, wherein the insert part forms a locking face of the locking mechanism part. An extension on the insert part is inserted between the two main bodies in such a way that secure fixation of the insert part is made possible. In addition, the two metallic main bodies and the insert part are provided with a plastics coating, so that the insert part can be securely fixed and at the same time the main bodies can be securely connected to each other.

A multi-layer construction of a locking mechanism part is also known from DE 10 2015 121 951 A1. In addition to constructing the locking mechanism main body from a number of lamellae, hardened supports are attached to the lamellae of, for example, the rotary latch as functional faces, such as a locking face. The use of thin-layer lamellae can positively influence the manufacturing costs of the locking mechanism parts.

In addition to the high demands on the stability of the locking mechanism parts, the costs of production, as well as the noise behavior and wear resistance, are aspects for continuous development and improvement of the locking mechanism parts. While wear resistance and noise behavior are demanded by car manufacturers, cost considerations are also paramount for the manufacturers. This is where the invention comes in. The object of the invention is to provide improved locking mechanism parts for a motor vehicle lock, with a particular aim of reducing costs, positively influencing noise development and increasing wear resistance.

According to the invention, the object is achieved by the features of independent claim 1. Advantageous embodiments of the invention are specified in the dependent claims. It should be noted, however, that the embodiments described below are not restrictive; rather, any variation of the features described in the description and the dependent claims is possible.

According to claim 1, the object of the invention is achieved by providing a locking mechanism part, in particular a rotary latch or a pawl, for a motor vehicle lock, comprising at least one locking face, a first metallic main body and a second metallic main body and a plastics layer, wherein the plastics layer surrounds the main bodies at least partially and is arranged at least partially between the main bodies, and wherein the plastics layer forms at least partially a part of the locking face. The inventive design of the locking mechanism parts now makes it possible to directly and significantly influence the noise behavior of the locking mechanism parts. An arrangement of the plastics layer in the area of the locking face offers the possibility that, on the one hand, a sufficiently durable locking face is provided by the metallic main bodies, and on the other hand, the plastics component can influence the engagement behavior with regard to noise and, in particular, can reduce the noise. In a main locking position of the locking mechanism, a high load lies on the locking face between the rotary latch and the pawl. This load substantially results from a sealing pressure that is applied to the moving part and seals the door or flap against environmental influences. Additionally, a rotary latch spring acts on the locking mechanism and especially on the rotary latch, so that overall a high moment is present in the rotary latch, which is absorbed by the pawl. When the locking mechanism is opened so that the door, flap or drawer can be opened, the pawl slides off the locking face, releasing the rotary latch. When separating the rotary latch and pawl, a separation noise may occur due to the high stress, which can be reduced by the plastics layer. On the one hand, the sliding of the pawl from the locking face of the rotary latch can generate a noise which can be reduced by the plastics layer, and on the other hand, the separation, i.e., the breaking of the engagement between rotary latch and pawl, can generate a noise which can also be reduced by the plastics layer.

The locking mechanism part according to the invention has a first metallic main body and at least one second metallic main body. The main bodies are preferably designed as sheets and are arranged parallel to each other, so that at least one locking face, preferably two locking faces, can be formed by adding the widths of the metallic sheets. The main bodies substantially correspond in their dimensions to those known from the familiar locking mechanism parts. The main difference is that the main bodies can be manufactured with a smaller thickness, resulting in cost advantages in the production of the main bodies.

The main bodies are connected to each other using the plastics layer. The plastics layer surrounds the main bodies in such a way that a plastics coating is formed around the locking mechanism parts, and at the same time the plastics layer is arranged between the main bodies. The plastics layer thus has a multifunction. On the one hand, the plastics layer forms a shell for the main bodies, so that, for example, a plastics layer is available in the bearing area for easy and quiet bearing; in addition, the plastics layer connects the main bodies to form a uniform part; and in addition, the plastics layer in the area of the locking face can positively influence the engagement behavior of the locking mechanism parts.

For locking mechanism parts, it can be advantageous if the plastics layer is arranged in the area of the locking face between the main bodies. A plastics layer located in the area between the main bodies offers the advantage of enabling a good bond between the plastics layer and the main bodies. The loads in the area of the locking face can be high, so the main bodies provide support for the plastics layer. Supporting the plastics layer promotes wear resistance, ensuring high wear resistance even under continuous stress on the locking face and the plastics layer.

In addition to arranging the plastics layer in the area between the main bodies, it is conceivable according to the invention that the plastics layer in the area of the locking face protrudes at least partially beyond the locking face. By extending the plastics layer beyond the locking face, additional damping material can be introduced into the area of the locking face. The protrusion of the plastics layer in the area of the locking face can have a damping effect on the one hand and on the other hand can provide a sliding surface for the adjacent locking mechanism parts. Preferably the rotary latch is designed according to the invention, but it is also conceivable to design the pawl with a middle layer as a plastics layer. The approach of designing the locking mechanism consisting of rotary latch and pawl with a middle layer of plastics in the area of the locking face is also conceivable according to the invention. In this case, one locking mechanism part or both locking mechanism parts may have a protrusion of the plastics layer in the area of the locking face.

If the plastics layer is arranged completely between the main bodies, a further advantageous embodiment of the invention results. A seamless, i.e., complete, formation of a plastics layer between the metallic main bodies can ensure a secure connection of the main bodies, so that the locking mechanism parts designed according to the invention can withstand the high loads in extreme situations. An extreme situation can occur, for example, if the motor vehicle is involved in an accident and very high forces act on, for example, a side door. In this case, the locking mechanism must ensure that the latch holder is held securely, so that the occupants of the motor vehicle can be protected by the cohesion of the body and the moving parts.

A further embodiment of the invention arises when at least one main body has at least one means for spacing the main bodies. In order to arrange the main bodies of the locking mechanism part in parallel, it has been found that it is advantageous if the main body is held in an injection molding tool by at least one means for spacing the main bodies. The spacing means allows for precise alignment of the main bodies within the locking mechanism part, resulting not only in the parallel arrangement of the main bodies but also in a plane, i.e., mutually aligned locking sub-faces. In other words, for example, both main bodies form a pre-ratchet on the locking mechanism part, wherein the pre-ratchet area as a whole is formed jointly by both main bodies. The parallel arrangement of the main bodies allows for a flat ratchet face in the pre-ratchet and/or main ratchet. The locking sub-faces of the main bodies are aligned with each other by spacing means. In addition to the locking sub-faces, it is also important that the openings of the axles for the locking mechanism parts are aligned in the main bodies. This means that the punched-out openings or bores in the main bodies are aligned relative to each other by the spacers in such a way that the bores are aligned relative to each other and can be securely and precisely passed through by an axle.

In a first embodiment of the invention, the spacing means is formed integrally with at least one main body. The main bodies for forming the locking mechanism part are stamped from a metal sheet and can be designed with a bore or punched out area for receiving the axle. In a parallel or separate manufacturing step, for example, depressions can be introduced into the main body, wherein the depressions can serve as spacers or spacing means in the injection molding tool. When an injection molding tool is mentioned here, it describes the manufacturing step of applying the plastics layer to the main body or main bodies. If one or more spacing means, i.e., for example depressions, are incorporated into the main body, the main bodies can be placed in an injection mold and held securely spaced in the injection molding tool. No additional tool holders are necessary to enable a parallel arrangement of the main bodies relative to each other. The spacing means, which are attached to the main body integrally, provide a cost-effective and simple way to space the main bodies. Of course, it is possible that spacing means are provided on only one main body, or on both main bodies, either in alignment or spaced apart from each other.

Another embodiment of the locking mechanism parts results from the fact that the spacing means is designed as a separate part, in particular as a stepped mandrel. A separate part could, for example, be a stepped mandrel that is inserted into openings in the main body. This allows for a parallel arrangement of the main bodies and an overall alignment in the injection molding tool. One embodiment can be a separate stepped mandrel that is inserted into the main bodies on both sides and integrates into the locking mechanism part during overmolding of the main bodies. In addition to using two or more stepped mandrels that can be arranged distributed over the base area of the main bodies, it is also conceivable that a stepped mandrel is used in the area of the bore for the axles of the locking mechanism part. The stepped mandrel can be designed in such a way that the stepped mandrel itself holds the main bodies parallel and spaced apart. In addition to securing the main bodies with the stepped mandrel, it is possible in every embodiment to hold the locking mechanism part or the main bodies in the injection molding tool at the non-overmolded areas, such as the locking faces.

Furthermore, it can be advantageous if an entry area of the rotary latch is at least partially covered with the plastics layer, in particular in an insertion face of the latch holder. The locking mechanism parts are mostly covered with the plastics layer, at least in the areas that serve as guide faces. The areas that serve as stops or guide faces for other parts can also be covered with the plastics layer. When the locking mechanism is closed, the latch holder engages with the rotary latch. In this area, a buffer pocket is usually provided, which can be formed from the plastics layer. After the rotary latch has engaged in the pre-ratchet, it is possible for the rotary latch to be electrically actuated from the pre-ratchet to the main ratchet by means of a closing drive. During the movement of the rotary latch from the pre-ratchet to the main ratchet, the latch holder passes over an insertion face on the rotary latch when, for example, the side door is closed. It has now proven particularly advantageous that the overmolding, and especially the intermediate layer between the main bodies of the rotary latch, results in a one-piece encasement and intermediate layer. In particular, the intermediate layer ensures high stability and very good attachment of the plastics layer in the area of the insertion face of the latch holder. This increases the wear resistance of the locking mechanism part and especially the rotary latch.

If the main bodies have a thickness of less than 3 mm, preferably a thickness of approximately 2 mm, a further embodiment of the invention is achieved. Preferably, the total thickness of the locking mechanism parts is 6 mm or less. By constructing the locking mechanism parts using a two-or multi-layer technique, the thickness of the metallic core, consisting of the main bodies, can be reduced. Preferably the thickness of the main body is approximately 2 mm, so that a total thickness including the outer plastics layer plus the intermediate layer of 6 mm can be produced. By reducing the metallic inserts in the locking mechanism parts, the costs for the locking mechanism parts can be reduced. Sheets of 2 mm thickness can be punched, which can then be formed into a single piece with a metallic core through plastics injection molding and the plastics layer. By reducing the sheet thickness used to manufacture the metallic cores of the locking mechanism parts, the costs for the locking mechanism parts can be reduced. In one embodiment of the invention, it may also be provided that the two or more main bodies have a different thickness. For example, one main body with a thickness of, say, 2 mm and another main body with a thickness of 4 mm can be provided.

It can also be advantageous if the plastics layer arranged between the main bodies has a thickness of less than 2 mm, preferably a thickness of approximately 1 mm. In one embodiment of the invention, the thickness of the plastics layer arranged between the main bodies can also be less than 1 mm. The intermediate layer between the main bodies serves to attach the main bodies to each other, and in combination with the encasement of the locking mechanism parts to stabilize the locking mechanism part as a whole. The intermediate layer also allows for higher strengths in the attachment of the plastics layer and, in particular, in the encasement of the locking mechanism part.

Preferably, the locking mechanism parts are formed from main bodies with a uniform thickness, so that a symmetrical structure of the locking mechanism parts can be achieved. This is particularly advantageous in that it allows work with uniform main bodies, which in turn reduces the costs for manufacturing the locking mechanism parts. In addition to the cost advantage, the noise development in the locking mechanism can be reduced by forming the locking face with an intermediate layer of plastic. Wear resistance can also be increased by improving the bonding of the plastics layer, so that, considering all the advantages of the inventive design of the locking mechanism parts, an improved rotary latch or improved pawl can be achieved.

In the following, the invention is explained in more detail with reference to the accompanying drawings on the basis of exemplary embodiments. However, the principle applies that the exemplary embodiments do not limit the invention, but merely reflect advantageous embodiments of the invention. The features depicted can be implemented individually or in combination with further features of the description as well as the claims-individually or in combination.

In the figures:

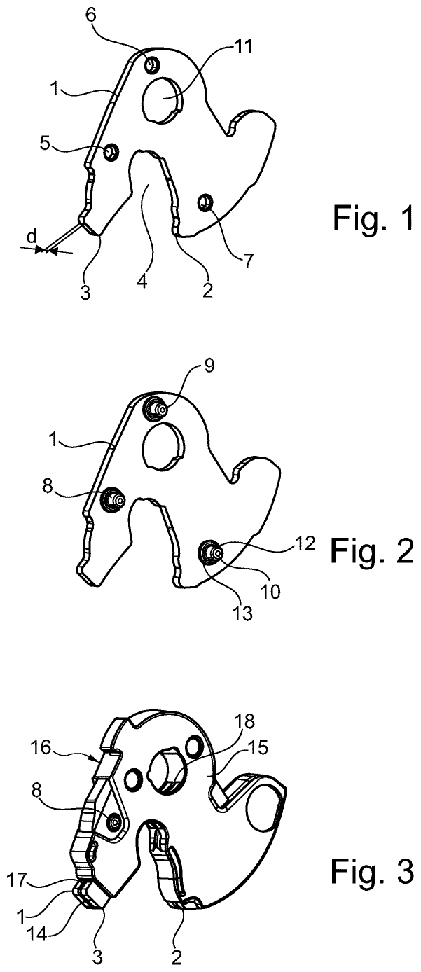

FIG. 1 shows a three-dimensional view of a main body of a locking mechanism part,

FIG. 2 shows a three-dimensional view of the main body according to FIG. 1 with inserted spacing means,

FIG. 3 shows a rotary latch with a plastics layer, formed from the main bodies according to FIGS. 1 and 2,

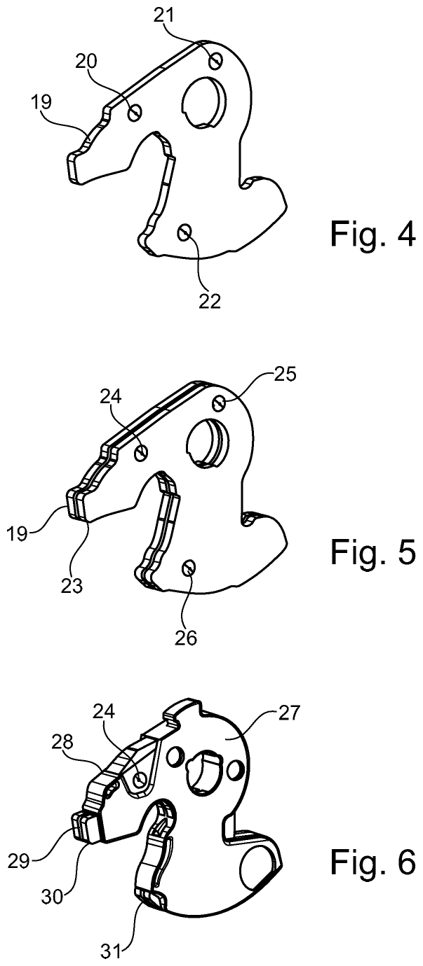

FIG. 4 shows a three-dimensional view of an alternative embodiment of a main body with depressions,

FIG. 5 shows two joined main bodies according to FIG. 4 in a symmetrical structure, with mirror-image main bodies, and

FIG. 6 shows the main bodies according to FIG. 5 with a plastics layer.

FIG. 1 shows a main body 1 in a three-dimensional view as a punched sheet part. The main body 1 is part of a rotary latch, which in its final version is designed with a pre-latch 2 and a main latch 3. The main body 1 has an inlet mouth 4 for a latch holder (not shown), as well as openings 5, 6, 7 for receiving spacing means 8, 9, 10, which are shown in FIG. 2. A further recess 11 in the main body 1 serves to accommodate a rotary latch axle. The main body 1 consists of a metallic sheet and has a uniform thickness d over its entire extent. The openings 5, 6, 7 and the recess 11 can, for example, be formed directly into the main body 1 during the punching process for the production of the metallic main body 1.

FIG. 2 shows the main body with inserted spacing means 8, 9, 10, wherein the spacing means 8, 9, 10 are designed as stepped mandrels 8, 9, 10. The stepped mandrels 8, 9, 10 have different diameters, with an insertion area 12, which is only once provided with a reference sign, being designed such that the insertion area 12 corresponds to the diameters of the openings 5, 6, 7.

In addition to the insertion area 12, the stepped mandrels 8, 9, 10 have a larger diameter 13, so that the stepped mandrels 8, 9, 10 serve as spacers between the main bodies 1, 14 in addition to aligning the main bodies 1 relative to each other.

FIG. 3 shows the rotary latch 16, which is provided with a plastics layer 15, in a finished overmolded form. The main bodies 1, 14 and a stepped mandrel 8 can be seen. The main bodies 1, 14 are connected to each other by an intermediate layer 17. It can be clearly seen that the main ratchet 3 is formed by the main bodies 1, 14 and the intermediate layer 17. The same applies to the pre-ratchet 2. As can be clearly seen, the rotary latch 16 is only partially surrounded by the plastic layer 15. Particularly in the area where a rotary axle is mounted, metallic surfaces 18 can also be seen.

FIG. 4 shows an alternative embodiment of a main body 19. The main body 19 has depressions 20, 21, 22 which serve as spacing means. The other parts of the main body 19 correspond to those of the aforementioned main bodies 1, 14.

FIG. 5 now shows two mirror-image main bodies 19, 23. The main bodies 19, 23 are formed as mirror images of each other, so that the depressions 20, 21, 22 are adjacent to the depressions 24, 25, 26. The depressions 20, 21, 22, 24, 25, 26 can, for example, be formed into the main bodies 19, 23 by means of deep drawing. In one exemplary embodiment of the invention, it may also be provided that the contours of the main bodies 1, 14 are designed differently.

FIG. 6 shows the rotary latch 28 encased by a plastics layer 27. The finished rotary latch 28, as shown in FIG. 6, can be taken directly from an injection molding tool. The intermediate layer 29 can again be seen in the area of the locking faces 30, 31.

### LIST OF REFERENCE SIGNS

1, 14, 19, 23 Main body
2 Pre-ratchet
3 Main ratchet
4 Inlet mouth
5, 6,7 Openings
8, 9, 10 Stepped mandrels, spacing means
11 Recess
12 Insertion area
13 Diameter
15,27 Plastics layer
16,28 Rotary latch
17,29 Intermediate layer
18 Metallic surface
20, 21, 22, 24, 25, 26 Depression
30,31 Locking face
d Thickness

1. A locking mechanism part, in particular a rotary latch or a pawl, for a motor vehicle lock comprising at least one locking, a first metallic main body, a second metallic main body and a plastics layer, wherein the plastics layer surrounds the main bodies at least partially and is arranged at least partially between the main bodies, wherein the plastics layer forms at least partially a part of the locking face.

2. The locking mechanism part according to claim 1, wherein the plastics layer is arranged in the area of the locking face between the main bodies.

3. The locking mechanism part according to claim 1, wherein the plastics layer projects beyond the locking face at least partially in the area of the locking face.

4. The locking mechanism part according to claim 1, wherein the plastics layer is arranged between the main bodies.

5. The locking mechanism part according to claim 1, wherein at least one main body has at least one spacing means for the main bodies.

6. The locking mechanism part according to claim 5, wherein the spacing means is formed integrally with the main body.

7. The locking mechanism part according to claim 5, wherein the spacer is designed as a separate part, in particular as a stepped mandrel.

8. The locking mechanism part according to claim 1, wherein an inlet area of the rotary latch is at least partially covered, in particular in an insertion face of the latch holder, completely with the plastics layer.

9. The locking mechanism part according to claim 1, wherein the main bodies have a thickness of less than 3 mm, preferably a thickness of approximately 2 mm.

10. The locking mechanism part according to claim 1, wherein the plastics layer arranged between the main bodies has a thickness of less than 2 mm, preferably a thickness of approximately 1 mm.
